(19) United States
(12) Patent Application Publication
(10) Pub. No.: US 2008/0148011 A1
(43) Pub. Date: Jun. 19, 2008

(54) Carry/Borrow Handling

(75) Inventors: Vinodh Gopal, Westboro, MA (US); Gilbert M. Wolrich, Framingham, MA (US); Gunnar Gaubatz, Worcester, MA (US); Daniel Cutter, Maynard, MA (US); Wajdi Feghali, Boston, MA (US); Kaan Yuksel, Worcester, MA (US); Erdinc Ozturk, Worcester, MA (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/610,897

(22) Filed: Dec. 14, 2006

(51) Int. Cl. G06F 9/30

(52) U.S. Cl. 712/22

(57) ABSTRACT

The present disclosure provides a system and method for performing carry/borrow handling. A method according to one embodiment may include generating a first result having a first carry or borrow from a first mathematical operation and storing the first carry or borrow and a first pointer address in a temporary register. The method may further include generating a second result having a second carry or borrow from a second mathematical operation and calling a subroutine configured to perform carry and borrow handling. The method may also include copying the first pointer address from the temporary register into a global variable. Of course, many alternatives, variations and modifications are possible without departing from this embodiment.

### FIELD

The present disclosure describes a system and method for carry/borrow handling.

### BACKGROUND

Some processors may be capable of performing extensive mathematical operations on vectors of arbitrary length. For example, conventional processors may be able to perform arithmetic logic unit (ALU) operations such as, add, subtract, multiply, divide, shift, etc. Many of these operations may produce a carry out of one register and/or a borrow from another. As large amounts of data continue to be processed at an increasing rate, efficient arithmetic/shift operations and carry-handling techniques may be required.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one exemplary embodiment in accordance with the present disclosure;

FIG. 2 is a diagram illustrating another exemplary embodiment in accordance with the present disclosure;

FIG. 3 is a diagram illustrating yet another exemplary embodiment in accordance with the present disclosure;

FIG. 4 is a block diagram showing encryption circuitry in accordance with an embodiment of the present disclosure;

FIG. 5 is a block diagram showing a security processing circuitry in accordance with an embodiment of the present disclosure;

FIG. 6 is a block diagram depicting portions of a network processor in accordance with one embodiment of the present disclosure;

FIG. 7 is a diagram illustrating one exemplary system embodiment; and

FIG. 8 is a flowchart showing operations consistent with yet another exemplary embodiment.

Although the following Detailed Description will proceed with reference being made to illustrative embodiments, many alternatives, modifications, and variations thereof will be apparent to those skilled in the art.

### DETAILED DESCRIPTION

Some arithmetic operations may require the addition of multiple vectors. In these instances, a carry generated in one location may need to propagate an arbitrary distance into the high part of the result, which may be very unlikely when using a random bit pattern. Using conventional techniques, the carry correction operations required to solve this problem may require an excessive amount of microprogram code.

Generally, the embodiments described herein provide a more efficient approach for carry/borrow handling in a processor. In accordance with the present disclosure, carry and borrow handling may be performed using a single, separate, subroutine (i.e., an independent subsection of microcode), which may be conditional upon the status of a boolean condition flag. The embodiments described herein may provide an efficient implementation (i.e., having little or no delay) in situations where the branch to the conditional subroutine is selected, as well as, in situations where the branch is not selected. This conditional subroutine may act as a delayed branch on a carry/borrow flag from a previous instruction to enable the branch to hide in the shadow of a later executed instruction.

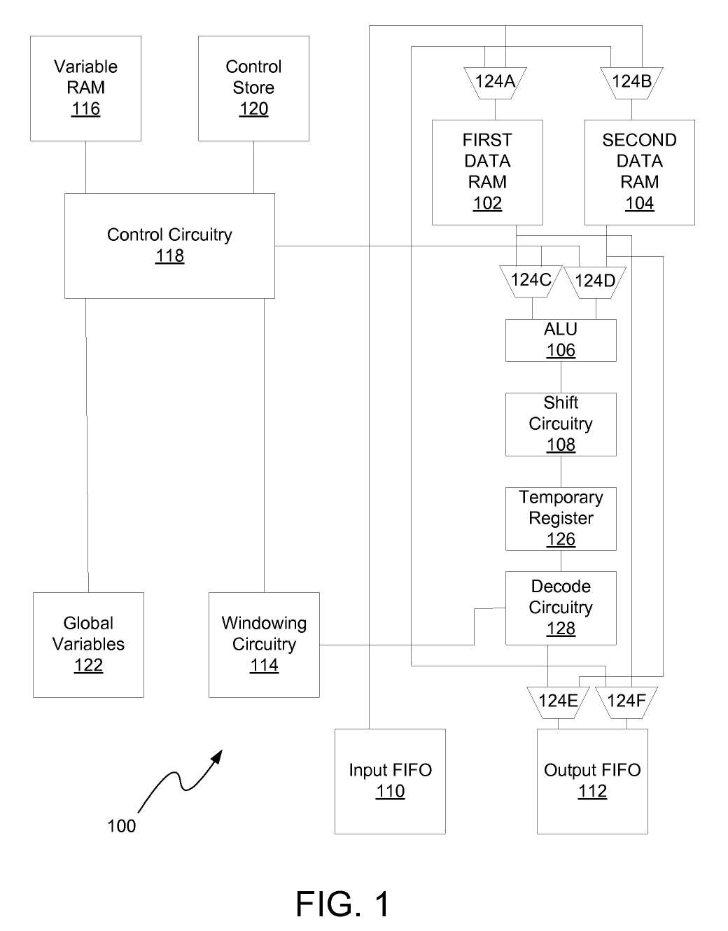

FIG. 1 is a block diagram illustrating one exemplary embodiment of a modular math processor (MMP) 100. MMP 100 may be configured to perform arithmetic logic unit (ALU) operations (e.g., addition/subtraction, multiplication, shift, logical operations, etc.) upon vectors of arbitrary length. MMP 100 may also be capable of overlapping consecutive vector operations in parallel to optimize performance. Further, MMP 100 may be configured to allow certain programs to call and/or return subroutines, such as those required to perform modular exponentiation problems. In some embodiments, MMP 100 may be optimized to perform operations upon vectors up to, and in excess of 8000 bits.

MMP 100 may also include a number of memory devices, such as, first data RAM 102 and second data RAM 104. Data RAMs 102 and 104 may be capable of receiving data from a First-In, First-Out (FIFO) unit 110 and may store operands before being sent to other components associated with MMP 100, such as ALU 106. ALU 106 may be a general purpose ALU such as a standard 64-bit ALU found in some general purpose processors. ALU 106 may also include condition codes that may allow a programmer to compare results, use conditional branches, etc. The output of ALU 106 may be provided to other components within MMP 100 such as shift circuitry 108. Shift circuitry 108 may be configured to perform shifting operations using either a right-to-left or a left-to-right mode. In some embodiments shift circuitry 108 may be configured to perform a conditional shift. For example, a conditional right shift may be used depending upon whether the output from ALU 106 is odd (i.e., do not shift) or even (i.e., shift), which may be useful for speeding up certain operations (e.g., greatest common divisor algorithms). As mentioned above, MMP 100 may include a number of FIFO units, such as input FIFO 110 and output FIFO 112. Input FIFO 110 may be configured to transmit data through MUXes 124 a, b (e.g., 2-to-1 mux) to Data RAMs 102 and 104 for storage. Moreover, some data may be transmitted through multiplexers (MUXes) 124 c,d to ALU 106 as necessary. MMP 100 may execute a variety of different instructions depending upon the source and destination operand configuration. Some instructions may write the contents of input FIFO 110 directly into Data RAMs 102, 104. Additionally or alternatively, some instructions may allow for the contents of input FIFO 110 to be written directly into ALU 106.

MMP 100 may further include windowing circuitry 114, which may be configured to calculate variable windows used in certain operations, such as those required for modular exponentiation. Windowing circuitry 114 may be configured to perform sliding or fixed exponent windowing, depending upon the selected mode. Windowing circuitry 114 may calculate windows on long exponents for the purpose of reducing the number of multiplications required in modular exponentiation. In some embodiments, the exponent may be treated as a binary string and the bits may be scanned in either a left-to-right or right-to-left orientation. Modular exponentiation operations may scan the bits of the exponent to determine the next group (i.e., window) to be multiplied as the exponent slides from left to right.

MMP 100 may include additional components, such as, control circuitry 118, which may be configured to direct the operation of MMP 100. Control circuitry 118 may be in communication with numerous components within MMP 100, including, but not limited to, windowing circuitry 114, variable RAM 116, control store memory 120, global variables 122 and multiplexers (MUXs) 124 (a-f). Variable RAM 116 may be in communication with Data RAMs 102, 104 and may be used to make references to variables in first and second data RAMs 102, 104. Variable RAM 116 may be divided into a number of different scopes or modules, which may define where a given variable is defined as well as where it may be used. Control store memory 120 may be configured to contain the microprogram code for the CPU, which may be accessed and controlled via control circuitry 118. Global variables 122 may be accessed from anywhere in the program via control circuitry 118. MMP 100 may further include a temporary register 126 capable of storing carry/borrow data as well as decode circuitry 128, which will each be discussed in greater detail below.

In one exemplary embodiment, MMP 100 may be configured to perform efficient carry/borrow handling when adding or subtracting vectors of unequal length by calling a single separate carry/borrow handling subroutine. For example, when adding two vectors of unequal length, a carry generated in one location may need to propagate an arbitrary distance into the higher part of the result. This conditional subroutine call may act like a delayed branch and may evaluate the carry/borrow flag from a next-to-last instruction from MMP 100. The MMP instructions, may be used, inter alia, to perform vector addition and subtraction in MMP 100. Since the subroutine may be called infrequently, the branch to subroutine may have a very fast execution path when it is not selected. In some embodiments, this conditional subroutine may be activated using a state bit that may be set via the next-to-last MMP instruction, which may also indicate whether an addition or subtraction operation has occurred. Thus, a single conditional subroutine call may be used for both carry and borrow correction code.

When the conditional subroutine is selected, global variables 122 (e.g., global variable G0) may have the pointer address the location in data RAMs 102 and/or 104 where the carry/borrow propagation needs to resume. The program may continue from this point in the subroutine by setting up a local variable using global variable G0. This pointer may correspond to the next-to-last MMP instruction's destination address for ALU write-back incremented by 1 (i.e., representing a resume address where carry/borrow would need to be propagated).

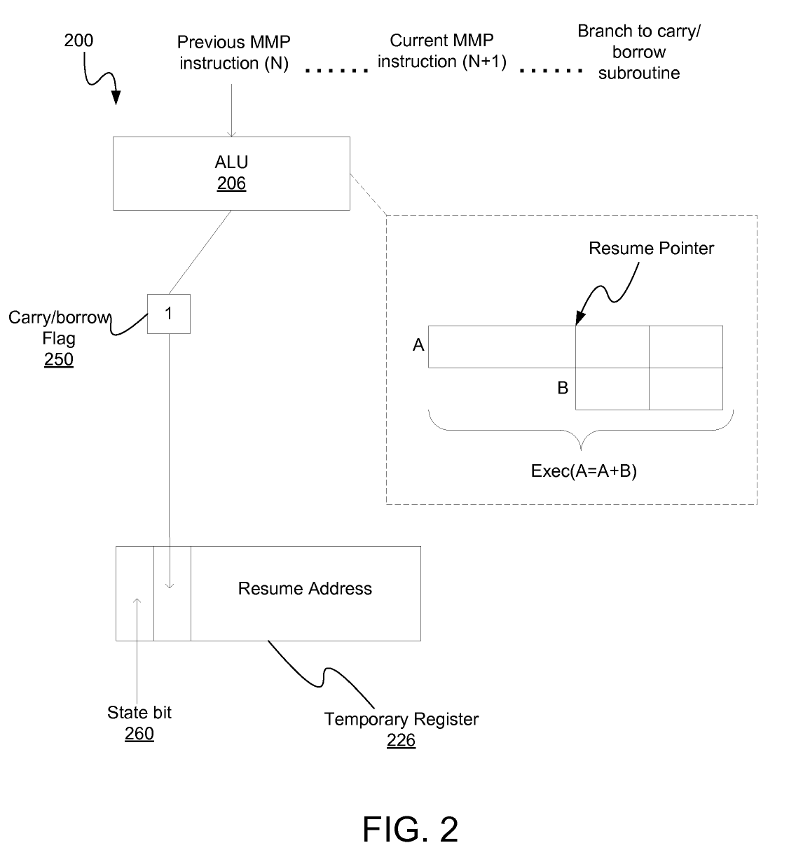

FIG. 2 shows another exemplary embodiment depicting the carry/borrow handling of the present disclosure. Diagram 200 illustrates, in further detail, portions of MMP 100. Diagram 200 includes a series of MMP instructions, which may be sent to ALU 206. In some embodiments, a branch to the carry/borrow subroutine may be preceded by at least two MMP instructions. In this embodiment, these two instructions may be previous MMP instruction (N) and current MMP instruction (N+1). A No operation (NOP) instruction may be inserted if a useful instruction cannot be promoted before the branch. One example of a possible program sequence is provided below:

MMP instruction #N
Optional setups or FIFO instructions // No setup may modify ALU
carry flag at this point
MMP instruction #N+1
Branch-sub-prev-carry/borrow // may depend on N's carry/borrow
state & next write-back address

In some embodiments, an instruction (e.g., previous MMP instruction (N)) requiring a mathematical operation may be sent to ALU 206. For example, such an instruction may be configured to execute A=A+B as shown in FIG. 2. This type of operation may produce a carry or borrow, which may be stored in carry/borrow flag 250. The current MMP instruction (N+1) may save the carry (or, alternatively, save the borrow if the previous MMP instruction (N) was a subtract) using carry/borrow flag 250 (e.g., prev-carry-borrow). The conditional subroutine may be issued after this (N+1) instruction, which may evaluate carry/borrow flag 250 after the current instruction begins executing. Carry/borrow flag 250, state bit 260 and resume address may be stored within temporary register 226. The resume address may be defined as the last ALU destination address of the previous (N) instruction, incremented by one. Temporary register 126 may be written with this address at the beginning of the current (N+1) MMP instruction.

An additional example of carry/borrow handling in accordance with an exemplary embodiment of the present disclosure is provided below. This embodiment provides a method for adding two vectors of unequal length using a reference count of the smaller vector incremented by one. Assume a first instruction that adds B[7:0] to A[7:0] with a reference count (RC)+1 (i.e., 8+1=a 9 word-vector) with the last word of B zeroed. The last word of B may be added to the corresponding word of the larger vector. Any additional carry propagation has a very low probability as all 64 bits of that word in the larger vector may be 1. Upon the execution of the first instruction, carry/borrow flag 250 & pointer address may be stored in temporary register 126 or 226. Temporary register 126 may be a 10-bit register, which may include carry/borrow flag 250, state bit 260 and the next pointer address indicating next ALU writeback location for a previous MMP instruction. State bit 260 may include data indicating whether the previous MMP instruction was an addition or subtraction operation. In some embodiments, the addresses may be real physical addresses to first data RAM (A) 102 and second data RAM (B) 104. This first instruction may run for a number of cycles (e.g., 9) and may have the carry/borrow flag 250 set. This may imply that the correct result is in A[8:0], however carry flag 250 may need to be added to the sub-vector A[15:9].

A second instruction may be executed before the conditional subroutine for carry/borrow correction may be issued. At the start of the second instruction, the addition carry flag, state bit & pointer value (9) may be saved to temporary register 126 and a number of cycles may be executed (e.g., 16). The carry may indicate that the first instruction was an addition operation (i.e., the hardware knows the opcode of the first instruction was an addition operation). The conditional subroutine may begin executing immediately after the second instruction is in progress. However, the conditional subroutine may need to delay for a couple of cycles until the second instruction has finished updating temporary register 126. If the preserved carry-bit=1, the carry/borrow subroutine may begin at the target address since the first instruction was an addition operation.

In some embodiments, prior to the execution of the first instruction of the conditional subroutine, MMP 100 may copy the pointer from temporary register 126 into global variable 122 (e.g., G0). At the start of the subroutine, the program may initialize a local variable (e.g., within first or second data RAM 102, 104) relative to global variable G0 & may then begin adding with carry in a loop until no carry remains.

In some embodiments, during a subtraction operation, the program may need to perform a computation of the form A[15:0]-B[7:0]. As expected, MMP 100 may need to store the subtraction carry/borrow flag of temporary register 126 at the beginning of the second instruction (e.g., in data RAMs 102 and/or 104). The pointer address may refer to the last address that was written from ALU 106 by the vector operation, incremented by 1. This may provide the next word requiring carry/borrow correction.

The MMP instructions may copy the carry/borrow flag, state bit and the next ALU write-back pointer into temporary register 126 at the beginning of a vector operation. Once the carry/borrow flag is set in temporary register 126 the branch to subroutine may be taken. If the branch to subroutine is taken, the pointer from temporary register 126 may be copied into global variables 122 (e.g., G0).

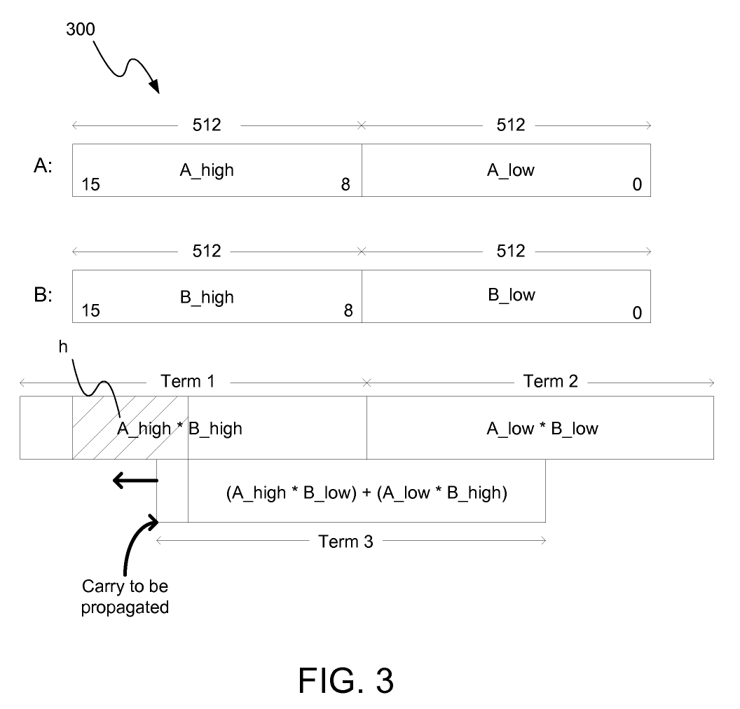

FIG. 3 is a diagram 300 illustrating another exemplary embodiment showing the carry handling techniques applied to a Karatsuba multiplication. Generally, Karatsuba multiplication expresses the multiplication of two numbers in terms of multiplications of numbers of half the size. A more thorough analysis of Karatsuba multiplication may be found in The Handbook of Applied Cryptography authored by Alfred Menezes et al., published Jan. 1, 1997 by CRC press. FIG. 3 depicts a single-level of a Karatsuba multiplication, showing two distinct 16 quadword vectors A and B. MMP 100 may be configured to utilize a number of different instruction words. For example, as used herein, a word may be 16 bits, a longword may be 32 bits and a quadword may be 64 bits. In this embodiment, A_high, A_low, B_high and B_low may all be 512 bit vectors (i.e., 8 quadwords each). As shown in FIG. 3, Term 1 may indicate A_high*B_high, Term 2 may indicate A_low*B_low and Term 3 may indicate (A_high*B_low)+(A_low*B_high). Term-3 may be added to the lower part of Term-1, thus requiring only 9 cycles (i.e., the length of the smaller vector (8)+1) for an MMP instruction. The carry-propagation through the hatched region “h” may be performed via the conditional subroutine call. In this example, the conditional subroutine may perform two iterative loops beginning at the resume-pointer (i.e., one word past the beginning of the hatched region “h”) until there is no more carry to be propagated. In some situations, since there may not be any carry, the expected run-time may be approximately 9 cycles for the main MMP instruction. In this example, there may be a carry coming from the summation of the last bit of Term 3 and the 512^{th} bit of Term 1. In order for the carry propagation to occur, all of the bits in at least the 9^{th} quadword of Term 1 must be ones. The length of the carry propagation may be determined by the number of all one quadwords of Term 1 after the 9^{th} quadword.

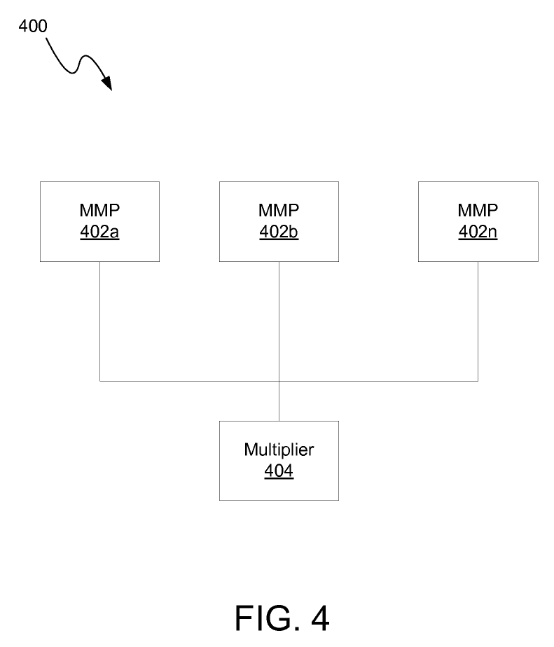

One exemplary embodiment depicting public key encryption (PKE) circuitry 400 is shown in FIG. 4. PKE circuitry 400 may include a plurality of modular math processors (MMPs) 402a, 402b, . . . , 402n, such as those described herein. Each MMP 402a-n may include at least one arithmetic logic unit (ALU) configured to perform the vector operations and carry/borrow handling as described above. PKE circuitry 400 may further include a multiplier 404 that may be operatively connected to modular math processors 402a-n. In at least one embodiment, multiplier 404 may be a large (515×515) unsigned integer multiplier. PKE circuitry 400 may be used in accordance with the present disclosure to perform modular exponentiation operations, such as those required by the Diffie-Hellman key exchange, DSA and RSA digital signatures, RSA encryption/decryption and primality testing.

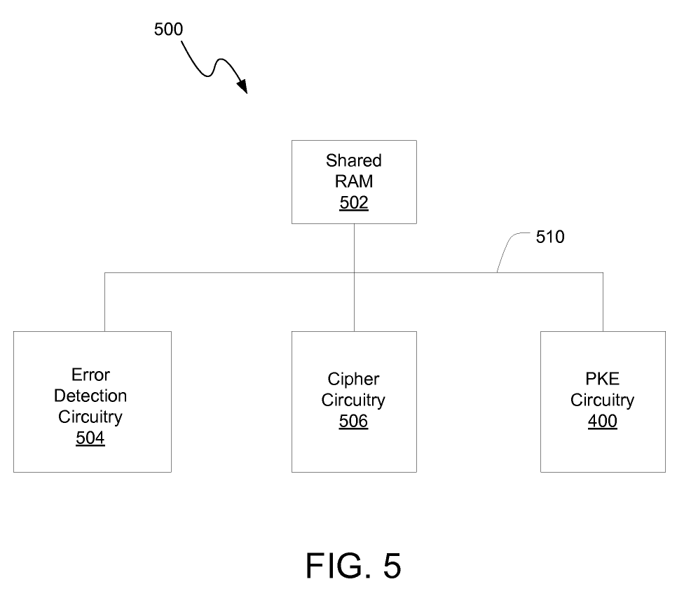

Referring now to FIG. 5, security processing circuitry 500 may include shared RAM 502, which may be in communication with error detection circuitry 504, cipher circuitry 506 and public key encryption (PKE) circuitry 400 through internal bus 510. Error detection circuitry 504 may be configured to perform hash functions that may be used as a redundancy check or checksum. Some types of redundancy checks could include, but are not limited to, parity bits, check digits, longitudinal redundancy checks, cyclic redundancy checks, horizontal redundancy checks, vertical redundancy checks, and cryptographic message digest. Security processing circuitry 500 may include both private and public key modules. Cipher circuitry 506 may be configured to generate private keys, which may include execution of symmetric and/or private-key data encryption algorithm such as the data encryption standard (DES) or advanced encryption standard (AES). Security processing circuitry 500 may be configured to execute an asymmetric key encryption algorithm and may include generating a public-key/private-key pair.

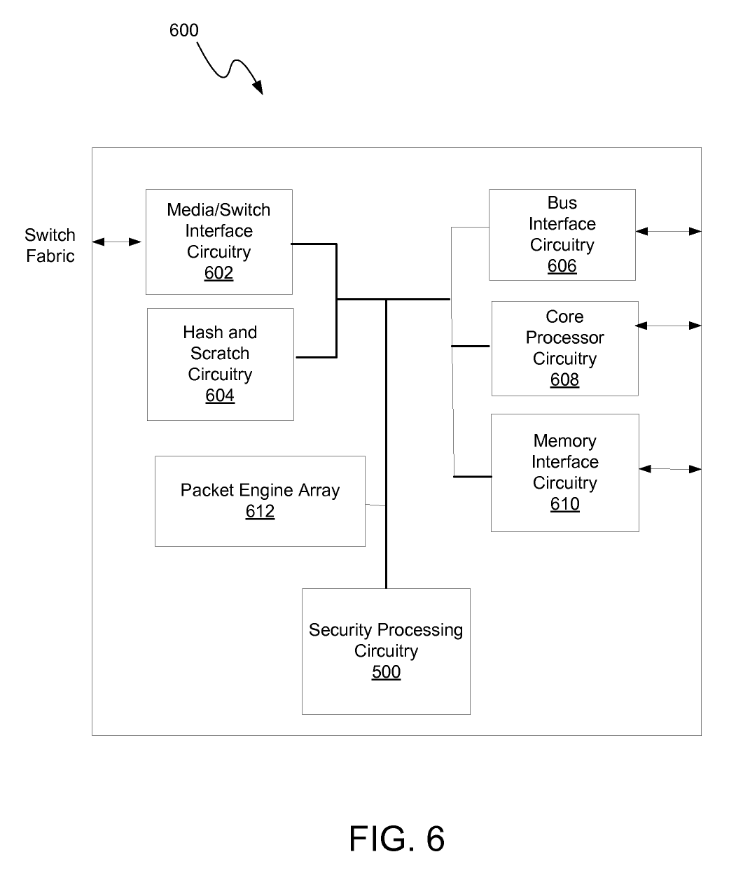

The methodology of FIGS. 1-5 may be implemented, for example, in a variety of multi-threaded processing environments. For example, FIG. 6 is a diagram illustrating one exemplary integrated circuit embodiment (IC) 600, which may be configured to include any or all of the embodiments described herein. “Integrated circuit”, as used in any embodiment herein, means a semiconductor device and/or microelectronic device, such as, for example, a semiconductor integrated circuit chip. The IC 600 of this embodiment may include features of an Intel® Internet eXchange network processor (IXP). However, the IXP network processor is only provided as an example, and the operative circuitry described herein may be used in other network processor designs and/or other multi-threaded integrated circuits.

The IC 600 may include media/switch interface circuitry 602 (e.g., a common switch interface (CSIX)) capable of sending and receiving data to and from devices connected to the integrated circuit such as physical or link layer devices, a switch fabric, or other processors or circuitry. The IC 600 may also include hash and scratch circuitry 604 that may execute, for example, polynomial division (e.g., 48-bit, 64-bit, 128-bit, etc.), which may be used during some packet processing operations. The IC 600 may also include bus interface circuitry 606 (e.g., a peripheral component interconnect (PCI) interface) for communicating with another processor such as a microprocessor (e.g. Intel Pentium®, etc.) or to provide an interface to an external device such as a public-key cryptosystem (e.g., a public-key accelerator) to transfer data to and from the IC 600 or external memory. The IC may also include core processor circuitry 608. Some embodiments, core processor circuitry 608 may comprise circuitry that may be compatible and/or in compliance with the Intel® XScale™ Core micro-architecture described in “Intel® XScale™ Core Developers Manual,” published December 2000 by the Assignee of the subject application. Of course, core processor circuitry 608 may comprise other types of processor core circuitry without departing from this embodiment. Core processor circuitry 608 may perform “control plane” tasks and management tasks (e.g., look-up table maintenance, etc.). Alternatively or additionally, core processor circuitry 608 may perform “data plane” tasks (which may be typically performed by the packet engines included in the packet engine array 612, described below) and may provide additional packet processing threads.

Integrated circuit 600 may also include a packet engine array 612. Packet engine array 612 may include a plurality of packet engines. Each packet engine may provide multi-threading capability for executing instructions from an instruction set, such as a reduced instruction set computing (RISC) architecture. Each packet engine in the array 612 may be capable of executing processes such as packet verifying, packet classifying, packet forwarding, and so forth, while leaving more complicated processing to the core processor circuitry 408. Each packet engine in the array 612 may include e.g., eight threads that interleave instructions, meaning that as one thread is active (executing instructions), other threads may retrieve instructions for later execution. Of course, one or more packet engines may utilize a greater or fewer number of threads without departing from this embodiment. The packet engines may communicate among each other, for example, by using neighbor registers in communication with an adjacent engine or engines or by using shared memory space.

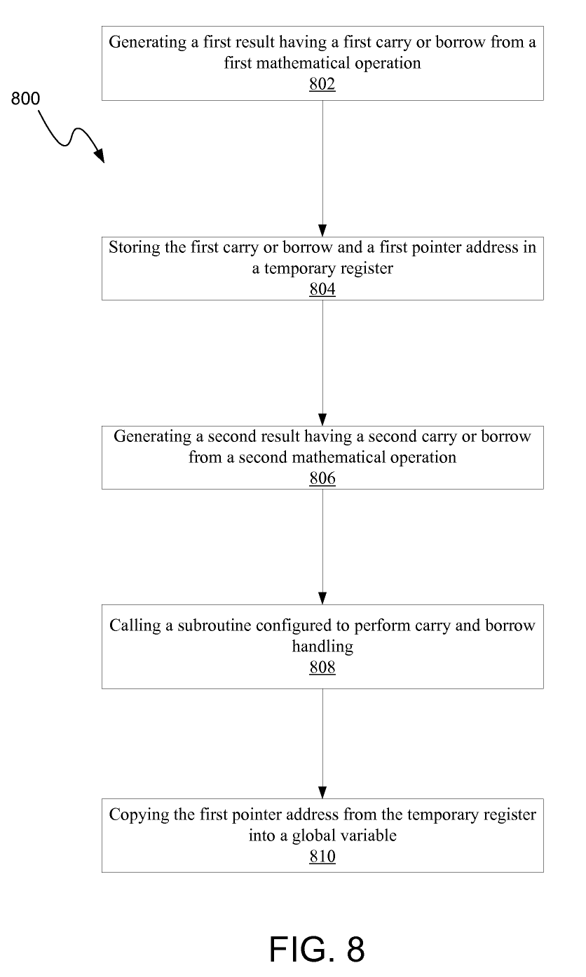

Integrated circuit 600 may also include memory interface circuitry 610. Memory interface circuitry 610 may control read/write access to external memory. Machine readable firmware program instructions may be stored in external memory, and/or other memory internal to the IC 600. These instructions may be accessed and executed by the integrated circuit 600. When executed by the integrated circuit 600, these instructions may result in the integrated circuit 600 performing the operations described herein, for example, those described below in FIG. 8. IC 600 may further include security processing circuitry 500. Security processor circuitry 500 may be configured to utilize the carry/borrow handling techniques described herein in order to perform various operations, such as those required in modular exponentiation and/or encryption/decryption operations which may be used in the generation a public key.

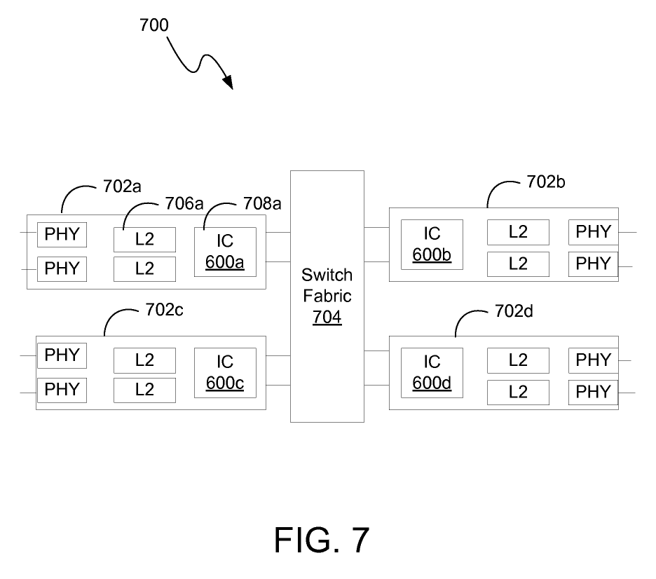

FIG. 7 depicts one exemplary system embodiment 700. This embodiment may include a collection of line cards 702a, 702b, 702c and 702d (“blades”) interconnected by a switch fabric 704 (e.g., a crossbar or shared memory switch fabric). The switch fabric 704, for example, may conform to CSIX or other fabric technologies such as HyperTransport, Infiniband, PCI-X, Packet-Over-SONET, RapidIO, and Utopia. Individual line cards (e.g., 702a) may include one or more physical layer (PHY) devices 702a (e.g., optic, wire, and wireless PHYs) that handle communication over network connections. The PHYs may translate between the physical signals carried by different network mediums and the bits (e.g., “0”-s and “1”-s) used by digital systems. The line cards may also include framer devices 706a (e.g., Ethernet, Synchronous Optic Network (SONET), High-Level Data Link (HDLC) framers or other “layer 2” devices) that can perform operations on frames such as error detection and/or correction. The line cards shown may also include one or more integrated circuits, e.g., 600a, which may include network processors, and may be embodied as integrated circuit packages (e.g., ASICs). In addition to the operations described above with reference to integrated circuit 600, in this embodiment integrated circuit 600a may also perform packet processing operations for packets received via the PHY(s) 702a and direct the packets, via the switch fabric 704, to a line card providing the selected egress interface.

Referring now to FIG. 8, an exemplary embodiment of a flowchart 800 is shown. Flowchart 800 includes operations that may be used to perform carry/borrow handling. Operations may include generating a first result having a first carry or borrow from a first mathematical operation (802) and storing the first carry or borrow and a first pointer address in a temporary register (804). Operations may further include generating a second result having a second carry or borrow from a second mathematical operation (806). Operations may additionally include calling a subroutine configured to perform carry and borrow handling (808) and copying the first pointer address from the temporary register into a global variable (810).

As used in any embodiment described herein, “circuitry” may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment herein may be implemented in software, firmware, hardwired circuitry and/or any combination thereof.

In some embodiments, the embodiments of FIGS. 1-7 may be configured as a “network device”, which may comprise for example, a switch, a router, a hub, and/or a computer node element configured to process data packets, a plurality of line cards connected to a switch fabric (e.g., a system of network/telecommunications enabled devices) and/or other similar device. Also, the term “cycle” as used herein may refer to clock cycles. Alternatively, a “cycle” may be defined as a period of time over which a discrete operation occurs which may take one or more clock cycles (and/or fraction of a clock cycle) to complete. Additionally, the operations described above with reference to FIG. 8 may be executed on one or more integrated circuits of a computer node element, for example, executed on a host processor (e.g., an Intel® Pentium® microprocessor and/or an Intel® Pentium® dual core processor and/or other processor that is commercially available from the Assignee of the subject application) and/or chipset processor and/or application specific integrated circuit (ASIC) and/or other integrated circuit.

Embodiments of the methods described herein may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

Accordingly, at least one embodiment described herein may provide numerous advantages over the prior art. For example, the carry/borrow techniques described herein may be used to conserve code-space by having a single subroutine per memory device that may be called upon to correct operations upon various sub-vectors via a saved carry/borrow flag and a resume pointer address. The carry/borrow flags and resume-pointer addresses may be stored in a register prior to the beginning of vector MMP operations to enable the conditional branch subroutine to execute quickly. Moreover, if the branch to the subroutine is not selected there is no delay in the critical path of normal execution.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A method comprising:
generating a first result having a first carry or borrow from a first mathematical operation;
storing the first carry or borrow and a first pointer address in a temporary register;
generating a second result having a second carry or borrow from a second mathematical operation;
calling a subroutine configured to perform carry and borrow handling; and
copying the first pointer address from the temporary register into a global variable.

2. The method according to claim 1, wherein the first pointer address corresponds to an address in memory where carry or borrow propagation is required.

3. The method according to claim 1, wherein calling a subroutine is determined by a carry/borrow flag.

4. The method according to claim 3, wherein the carry/borrow flag is set by a next-to-last MMP instruction.

5. The method according to claim 1, further comprising establishing a local variable in a data RAM using the global variable.

6. The method according to claim 1, further comprising storing the second carry or borrow and a second pointer address in the temporary register.

7. The method according to claim 1, wherein the temporary register includes a state bit, the state bit including data corresponding to an addition or subtraction operation.

8. The method according to claim 1, wherein the mathematical operations involve operations upon vectors of differing lengths.

9. The method according to claim 8, wherein the first mathematical operation includes operations upon a first vector having a first length and a shorter vector having a shorter length, the first mathematical operation having a reference count whose length corresponds to the shorter length incremented by one.

10. An apparatus, comprising:
an integrated circuit (IC) configured to generate a first result having a first carry or borrow from a first mathematical operation; the IC further configured to store the first carry or borrow and a first pointer address in a temporary register; the IC further configured to generate a second result having a second carry or borrow from a second mathematical operation; the IC further configured to call a subroutine configured to perform carry and borrow handling; the IC further configured to copy the first pointer address from the temporary register into a global variable.

11. The apparatus according to claim 10, wherein the first pointer address corresponds to an address in memory where carry or borrow propagation is required.

12. The apparatus according to claim 10, wherein the IC is further configured to call a subroutine is determined by a carry/borrow flag.

13. The apparatus according to claim 12, wherein the carry/borrow flag is set by a next-to-last MMP instruction.

14. The apparatus according to claim 10, wherein the IC is further configured to establish a local variable in a data RAM using the global variable.

15. The apparatus according to claim 10, wherein the IC is further configured to store the second carry or borrow and a second pointer address in the temporary register.

16. The apparatus according to claim 10, wherein the temporary register includes a state bit, the state bit including data corresponding to an addition or subtraction operation.

17. The apparatus according to claim 10, wherein the mathematical operations involve operations upon vectors of differing lengths.

18. The method according to claim 17, wherein the first mathematical operation includes operations upon a first vector having a first length and a shorter vector having a shorter length, the first mathematical operation having a reference count whose length corresponds to the shorter length incremented by one.

19. An article comprising a storage medium having stored thereon instructions that when executed by a machine result in the following:
generating a first result having a first carry or borrow from a first mathematical operation;
storing the first carry or borrow and a first pointer address in a temporary register;
generating a second result having a second carry or borrow from a second mathematical operation;
calling a subroutine configured to perform carry and borrow handling; and
copying the first pointer address from the temporary register into a global variable.

20. The article according to claim 19, wherein the first pointer address corresponds to an address in memory where carry or borrow propagation is required.

21. The article according to claim 19, wherein calling a subroutine is determined by a carry/borrow flag.

22. The article according to claim 21, wherein the carry/borrow flag is set by a next-to-last MMP instruction.

23. The article according to claim 19, further comprising establishing a local variable in a data RAM using the global variable.

24. The article according to claim 19, further comprising storing the second carry or borrow and a second pointer address in the temporary register.

25. The article according to claim 19, wherein the temporary register includes a state bit, the state bit including data corresponding to an addition or subtraction operation.

26. The article according to claim 19, wherein the mathematical operations involve operations upon vectors of differing lengths.

27. The article according to claim 26, wherein the first mathematical operation includes operations upon a first vector having a first length and a shorter vector having a shorter length, the first mathematical operation having a reference count whose length corresponds to the shorter length incremented by one.

28. A system comprising:
a plurality of line cards and a switch fabric interconnecting said plurality of line cards, at least one line card comprising:
at least one physical layer component (PHY); and
an integrated circuit (IC) configured to generate a first result having a first carry or borrow from a first mathematical operation; the IC further configured to store the first carry or borrow and a first pointer address in a temporary register; the IC further configured to generate a second result having a second carry or borrow from a second mathematical operation; the IC further configured to call a subroutine configured to perform carry and borrow handling; the IC further configured to copy the first pointer address from the temporary register into a global variable.

29. The apparatus according to claim 28, wherein the first pointer address corresponds to an address in memory where carry or borrow propagation may be required.

30. The apparatus according to claim 28, wherein the IC is further configured to call a subroutine via a carry/borrow flag.
